(19) United States
(12) Patent Application Publication
(10) Pub. No.: US 2026/0292830 A1
(43) Pub. Date: Sep. 24, 2026

(54) DEVICE, METHOD AND COMPUTER READABLE MEDIUM FOR COMMUNICATIONS

(71) Applicant: NEC Corporation, Tokyo (JP)

(72) Inventors: Xincai LI, Beijing (CN); Gang WANG, Beijing (CN)

(73) Assignee: NEC Corporation, Tokyo (JP)

(21) Appl. No.: 19/473,528

(22) PCT Filed: Apr. 11, 2023
(86) PCT No.: PCT/CN2023/087681

§ 371 Date: Oct. 8, 2025

(51) Int. Cl. H04W 72/21; H04L 1/00; H04W 74/0833

(52) U.S. Cl. CPC H04W 72/21; H04L 1/0003; H04W 74/0833

(57) ABSTRACT

Embodiments of the present disclosure relate to devices, methods and computer readable medium for a random access procedure. According to embodiments of the present disclosure, the terminal device receives a PUSCH configuration from a network device for a first message of a random access procedure. The PUSCH configuration is associated with a first PRU set for a SBFD time unit and a second PRU set for a non-SBFD time unit. The SBFD time unit is configured with frequency subbands for different link directions. Then, the terminal device transmits a PUSCH for the first message on at least one of the first PRU set and second PRU set to the network device. In this way, the random access procedure can be enhanced for the SBFD and non-SBFD time units appropriately.

### FIELD

Embodiments of the present disclosure generally relate to the field of communication, and in particular, to devices, methods and computer readable medium for a random access procedure.

### BACKGROUND

With the development of communication technology, a time unit (for example, a symbol, slot, frame, sub-frame and so on) can be divided into a plurality of frequency subbands in the frequency domain. The plurality of frequency subbands may be respectively used for different link directions, for example, uplink (UL) or downlink (DL). This time unit may be also referred to as subband non-overlapping full duplex (SBFD) time unit. In turn, a device for communication (for example, a network device or a terminal device) may perform the simultaneous transmission and reception of channel in different link directions on these time units, in order to improve communication efficiency.

In addition, the random access procedure has been designed for the terminal devices to access a cell (for example, a serving cell) or transition from an inactive state or an idle state to a connected state. Conventionally, the random access procedure may be implemented by a four (4)-step random access procedure or a two (2)-step random access procedure. In the two-step random access, the Message 1 or Message A is transmitted by transmitting a PRACH configured with a certain preamble and an associated PUSCH. Moreover, the association or mapping relationship between the PRACH having certain preamble and the PUSCH may depend on the amount of data to be transmitted. Furthermore, the above random access procedure may be further optimized for the SBFD time unit.

### SUMMARY

In general, example embodiments of the present disclosure relate to devices, methods, and computer readable medium for the random access procedure.

In a first aspect, there is provided a terminal device. The terminal device comprises a transceiver and a processor communicatively coupled to the transceiver. The processor is configured to cause the terminal device to receive, from a network device, a physical uplink shared channel (PUSCH) configuration for a first message of a random access procedure. The PUSCH configuration is associated with a first PUSCH Resource Unit (PRU) set for a SBFD time unit and a second PRU set for a non-SBFD time unit. The SBFD time unit is configured with frequency subbands for different link directions. The terminal device is further caused to transmit, on at least one of the first PRU set and second PRU set, a PUSCH for the first message to the network device.

In a second aspect, there is provided a network device. The network device comprises a transceiver and a processor communicatively coupled to the transceiver. The processor is configured to cause the network device to transmit, to a terminal device, a PUSCH configuration for a first message of a random access procedure. The PUSCH configuration is associated with a first PUSCH Resource Unit (PRU) set for a SBFD time unit and a second PRU set for a non-SBFD time unit. The SBFD time unit is configured with frequency subbands for different link directions. The network device is further caused to receive, on at least one of the first PRU set and second PRU set, a PUSCH for the first message to the network device.

In a third aspect, there is provided a method implemented at a terminal device. In the method, the terminal device receives, from a network device, a PUSCH configuration for a first message of a random access procedure. The PUSCH configuration is associated with a first PRU set for a SBFD time unit and a second PRU set for a non-SBFD time unit. The SBFD time unit is configured with frequency subbands for different link directions. Then, the terminal device transmits, on at least one of the first PRU set and second PRU set, a PUSCH for the first message to the network device.

In a fourth aspect, there is provided a method implemented at a network device. In the method, the network device transmits, to a terminal device, a PUSCH configuration for a first message of a random access procedure. The PUSCH configuration is associated with a first PRU set for a SBFD time unit and a second PRU set for a non-SBFD time unit. The SBFD time unit is configured with frequency subbands for different link directions. Then, the network device receives, on at least one of the first PRU set and second PRU set, a PUSCH for the first message to the network device.

In a fifth aspect, there is provided a computer readable medium having instructions stored thereon, the instructions, when executed on at least one processor, causing the at least one processor to perform the method of the third aspect or the fourth aspect.

It is to be understood that the summary section is not intended to identify key or essential features of example embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example environment in which some embodiments of the present disclosure can be implemented;

FIG. 2 illustrates a signaling process for the random access procedure according to some embodiments of the present disclosure;

FIGS. 3a to 3b illustrate examples of first PRU set for SBFD time units and second PRU set for non-SBFD time units according to some embodiments of the present disclosure;

FIG. 4 illustrate an example of the determination of invalid PRU set according to some embodiments of the present disclosure;

FIGS. 5a to 5b illustrate examples of the associations between a preamble group and a PO group according to some embodiments of the present disclosure;

FIGS. 6a to 6e illustrate examples of the mapping criteria between the preambles in SBFD or non-SBFD time units and PRUs in SBFD or non-SBFD time units according to some embodiments of the present disclosure;

FIG. 7 illustrates a flowchart of an example method implemented at a terminal device according to some embodiments of the present disclosure;

FIG. 8 illustrates a flowchart of an example method implemented at a network device according to some embodiments of the present disclosure; and

FIG. 9 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may be also incorporated one or multiple Subscriber Identity Module (SIM) as known as Multi-SIM. The term “terminal device” can be used interchangeably with a UE, a mobile station, a subscriber station, a mobile terminal, a user terminal, a wireless device or a reduced capability terminal device.

As used herein, the term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information. The terminal or the network device may work on several frequency ranges, e.g. FR1 (410 MHz-7125 MHz), FR2 (24.25 GHz to 71 GHz), 71 GHz to 114 GHz, and frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The network device may have the function of network energy saving, Self-Organizing Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware. In this disclosure, the subband and the frequency subband may be used interchangeable without any limitation. The group size of a RBG may be also referred to as the RBG size without any limitation. In this disclosure, the control channel may be interchangeably used with the physical downlink control channel (PDCCH) without any limitation.

The time unit configured with SBFD communication or configuration may be also referred to as SBFD time unit, and the time unit not configured with SBFD communication may be also referred to as non-SBFD time unit.

In this disclosure, the time unit may be any time duration, for example, symbol, slot, subframe and frame and so on. Without any limitation, only for illustration purposes, these time scales can be used interchangeably.

The term “random access channel (RACH)” used herein can be used exchangeable with the term “PRACH” or “initial access process” without any limitation.

The term “Message A or Message 1 or Msg 1 or Msg A” used herein refers to a request message for initiating the random access in the “two (2)-step random access procedure.

The term “MsgA PUSCH configuration or Msg 1 PUSCH configuration” used herein may refer to the resource configuration for the PUSCH of an Msg 1 or Msg A in the two-step random access procedure.

The term “PUSCH resource unit (PRU)” used herein may refer to the resources that are configured for a terminal device to transmit a PUSCH for the Message 1 or Message A in the random access procedure (for example, the two-step random access procedure). In this disclosure, the PRU may be used interchangeably with the term “PUSCH occasion (PO)” without any limitation.

The term “Frequency Division Multiplexing (FDM)” used herein may refer to PRUs or POs being frequency multiplexed for a certain number of times within a time unit.

The term “Physical Resource Block (PRB) or resource block” may refer to a resource base unit in the frequency domain.

The term “SBFD aware UE” used herein may refer to the terminal device which obtains the SBFD configuration for time units, for example, the subband division or location of the time units, and supports the SBFD operations with the network device.

The term “PRACH occasion (RO)” used herein may refer to the resources that are configured for a terminal device to transmit the PRACH for Message 1 or Message A in the random access procedure (for example, the two-step random access procedure). The terminal device may transmit a PRACH on a configured RO. Moreover, the PRACH may have a preamble that is associated with or mapped to a PO for the same Message 1 or Message A. Accordingly, the PRACH having this preamble or the RO which the PRACH having this preamble is transmitted on may be also referred to be associated with the PO, without any limitation.

As mentioned above, the random access procedure may be further optimized for the SBFD time unit. With the introduction of the SBFD operations, there may be more uplink resources allocated in the SBFD time units, for example, the DL time units (such as DL symbols or DL slots and so on) having the SBFD configuration or special(S) time units having the SBFD configuration. In this case, the SBFD time units or operations may be used during the initial access procedure to improve the PRACH capacity, since the SBFD time units can provide more UL resources to increase the PRACH capacity. As such, the PRACH collision and the initial access latency can be reduced. Furthermore, in the two-step random access procedure, the terminal device may transmit, in the Message 1 or Message A, the PRACH along with a traffic data channel, such as PUSCH. In this case, PUSCH resource configuration for Message 1 or Message A may be also optimized for the SBFD time unit.

In one direct solution, the PRUs or POs for transmitting PUSCH can be configured identically in the SBFD time units and non-SBFD time units. However, since the SBFD time units may have subbands for DL direction (which may be also referred to as “the DL subbands”) and the guard bands, some allocated POs that overlaps with DL subbands or the guard bands cannot be used for transmitting PUSCH (and/or PRACH) in the UL direction. Therefore, the identical POs (and/or ROs) between the SBFD time units and the non-SBFD time units may be inappropriate. In turn, how to configure the POs within the SBFD time units and non-SBFD time units and how to determine the valid of the POs should be further considered.

In addition, as mentioned above, the preamble of a PRACH transmitted on a RO can be mapped to the PRU or PO for the same Message 1 or Message A in a preconfigured criterion. In turn, once the PO being allocated in the SBFD time unit and non-SBFD time unit, the mapping relationship between the preambles (or RO, PRACH) and the PRUs (or PO, PUSCH) may be further designed. In one solution, the mapping between the preambles and PRU can be implemented in the following rules.

Each consecutive number of N_{preamble} preamble indexes from valid PRACH
occasions in a PRACH slot
- first, in increasing order of preamble indexes within a single PRACH occasion
- second, in increasing order of frequency resource indexes for frequency
multiplexed PRACH occasions
- third, in increasing order of time resource indexes for time multiplexed PRACH
occasions within a PRACH slot
are mapped to a valid PUSCH occasion and the associated DMRS resource
- first, in increasing order of frequency resource indexes f_{id} for frequency
multiplexed PUSCH occasions
- second, in increasing order of DMRS resource indexes within a PUSCH occasion,
where a DMRS resource index DMRS_{id} is determined first in an ascending order of
a DMRS port index and second in an ascending order of a DMRS sequence index
[4, TS 38.21]]
- third, in increasing order of time resource indexes t_{id} for time multiplexed
PUSCH occasions within a PUSCH slot
- fourth, in increasing order of indexes for Nₛ PUSCH slots
where N_{preamble} = ceil(T_{preamble}/T_{PUSCH}), T_{preamble} is a total number of valid
PRACH occasions per association pattern period multiplied by the number of
preambles per valid PRACH occasion provided by
rach-ConfigCommonTwoStepRA, and T_{PUSCH} is a total number of valid PUSCH
occasions per PUSCH configuration per association pattern period multiplied by the
number of DMRS resource indexes per valid PUSCH occasion provided by
msgA-DMRS-Config.

Furthermore, the power ramping operations for retransmitting the PRACH and PUSCH for the first message may be adjusted in view of the characteristics of the SBFD operations. Moreover, in the case of the SBFD operations, other enhancements for RACH procedure (such as, the mechanism for fallback to 4-step random access procedure) are also key aspects.

At least for solving the above technical issues, the example embodiments of the disclosure propose a mechanism for the random access procedure. In this mechanism, a terminal device receives a PUSCH configuration from a network device. The PUSCH configuration indicates PUSCH resources for a first message in a random access procedure. Specifically, the PUSCH configuration is associated with a first PRU set for a SBFD time unit and a second PRU set for a non-SBFD time unit. The SBFD time unit is configured with frequency subbands for different link directions. Then, the terminal device transmits, on at least one of the first PRU set and second PRU set, a PUSCH for the first message to the network device.

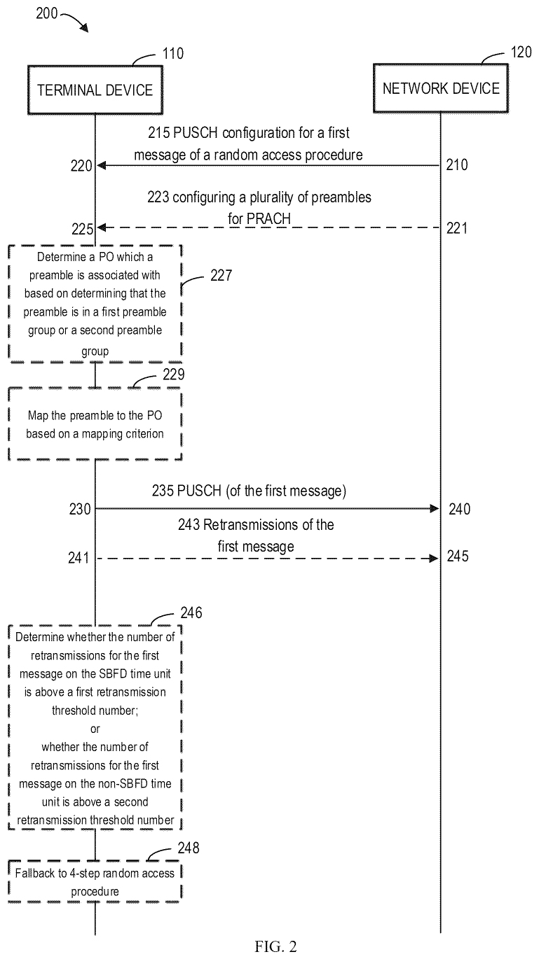

In this way, the random access procedure can be enhanced on the basis of the SBFD time unit. For illustrative purposes, principle and example embodiments of the present disclosure will be described below with reference to FIGS. 2-9. However, it is to be noted that these embodiments are given to enable the skilled in the art to understand inventive concepts of the present disclosure and implement the solution as proposed herein, and not intended to limit scope of the present application in any way.

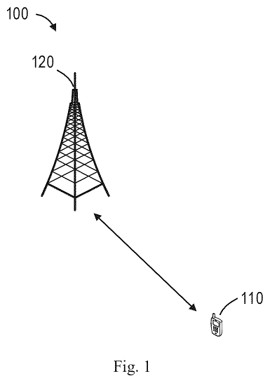

FIG. 1 illustrates an example environment 100 in which example embodiments of the present disclosure can be implemented.

The environment 100, which may be a part of a communication network, comprises a terminal device 110 and a network device 120. In some embodiments, the communication network may include NTN, NB-IoT and/or eMTC. In some other embodiments, the communication network may include any other possible communication network. It is to be understood that the number of network devices and terminal devices is given only for the purpose of illustration without suggesting any limitations. The communication network may include any suitable number of network devices and/or terminal devices adapted for implementing embodiments of the present disclosure. Although not shown, it would be appreciated that one or more terminal devices may be located in the environment 100. Without any limitation, the network device 120 supports the SBFD communication. For example, the network device 120 may transmit DL channel to the terminal device 110 and receive UL channel from another terminal device (not shown in FIG. 1A) in the SBFD time unit, simultaneously. In this disclosure, the non-SBFD time unit may be UL only time unit or DL only time unit.

FIG. 2 illustrates a signaling process 200 for the PRACH configuration according to some embodiments of the present disclosure. For illustrative purposes, the process 200 will be described with reference to FIG. 1.

In the signaling 200, the network device 120 transmits (210) a PUSCH configuration 215 for a first message of a random access procedure to the terminal device 110. The PUSCH configuration 215 is associated with a first PRU set for a SBFD time unit and a second PRU set for a non-SBFD time unit. At the terminal device 110 side, the terminal device 110 receives (220) the PUSCH configuration. The PUSCH configuration may respectively indicate the first PRU set for the SBFD time unit and the second PRU set for the non-SBFD time unit in several candidate manners. It is to be understood that although the embodiments in this disclosure are mainly discussed with respect to the PUSCH, the embodiments may be also applied to any other signaling or channel, for example, the uplink data channel, without any limitation.

In a first candidate manner, the PUSCH configuration may include a common set of parameters (which may be also referred to as a first common set of parameters), a SBFD set of parameters and a non-SBFD set of parameters. Then, based on the first common set of parameters and the SBFD set of parameters, the terminal device 110 may determine the first PRU set within one or more SBFD time units. Based on the first common set and the non-SBFD set of parameters, the terminal device may determine the second PRU set within one or more non-SBFD time units. In an example, in addition to the PRU (or PO) resource configuration predefined for the non-SBFD time units (for example, MsgA-PUSCH-Config or MsgA-PUSCH-Resource IE), further configurations are added for PO (or PRU) determination on the SBFD symbols or transmitting MsgA PUSCHs on SBFD symbols.

Specifically, a candidate configured parameter of the SBFD set of parameters may include a first PRU number of frequency division multiplexed (FDM) PRUs in the SBFD time unit, a first resource block (RB) number for a PRU in the SBFD time unit, and/or a first modulation and coding scheme (MCS) order. In turn, a candidate configured parameter of the non-SBFD set of parameters may correspondingly include a second PRU number of FDM PRUs in the non-SBFD time unit, a second RB number for another PRU in the non-SBFD time unit, and/or a second MCS order. It is to be understood that the candidate configured parameters in the SBFD set of parameters may also not correspond to the candidate configured parameters in the non-SBFD set of parameters one by one, without any limitation.

In addition, for adapting the PRU set to the SBFD time units, the value range for the parameters of the SBFD set of parameters may be limited, since the frequency resources in the SBFD time units are less than that in the non-SBFD time units generally. Accordingly, the maximum value of at least one candidate configured parameter (for example, the first PRU number) of the SBFD set of parameters may be smaller than another maximum value of at least one corresponding candidate configured parameter (for example, the second PRU number) of the non-SBFD set of parameters.

In an example, for the SBFD symbols, a new set of parameters for UE to determine the PO and transmit PUSCH can be additionally configured. Then, UE can determine different PO number, frequency position, symbol position, MCS, mapping type, or DMRS configuration in SBFD symbols. Alternatively, the above embodiments may be also expressed as below:

At least one of the below new parameters can be added in TS 38.331
MsgA-PUSCH-Config or MsgA-PUSCH-Resource IE for UE to determine the PUSCH
resource for MSGA on SBFD symbols.

| | |
|---|---|
| ♦ | nrofMsgA-PO-FDM-SBFD (the configured value can be {1,2,4}). |
| | frequencyStartMsgA-PUSCH-SBFD, guardBandMsgA-PUSCH-SBFD. |
| | nrofPRBs-PerMsgA-PO-SBFD (the configured value can be 1~16), wherein the |
| | nrofMsgA-PO-FDM-SBFD may indicate to the number of POs that are frequency |
| | multiplexed in a time unit; the frequencyStartMsgA-PUSCH-SBFD may indicate |
| | the starting RB for the lowest PO in the SBFD time unit; the |
| | guardBandMsgA-PUSCH-SBFD may indicate the guardband width for two |
| | adjacent FDM POs in the SBFD time unit; the nrofPRBs-PerMsgA-PO-SBFD |
| | may indicate the number of PRBs per PO. |
| ♦ | msgA-PUSCH-TimeDomainOffset-SBFD, |
| | msgA-PUSCH-TimeDomainAllocation-SBFD, |
| | startSymbolAndLengthMsgA-PO-SBFD, mappingTypeMsgA-PUSCH-SBFD. |
| | nrofMsgA-PO-PerSlot-SBFD, guardPeriodMsgA-PUSCH-SBFD, wherein the |
| | msgA-PUSCH-TimeDomainOffset-SBFD may indicate the time offset relative to |
| | a certain time location of PRACH; the |
| | msgA-PUSCH-TimeDomainAllocation-SBFD may indicate the time domain |
| | resources for the PO; the startSymbolAndLengthMsgA-PO-SBFD may indicate |
| | the starting symbol for the first PO in the SBFD time unit; the |
| | mappingTypeMsgA-PUSCH-SBFD may indicate the mapping type for PUSCH; |
| | the nrofMsgA-PO-PerSlot-SBFD may indicate the number of POs per slot in the |
| | time domain without considering the FDM; and the |
| | guardPeriodMsgA-PUSCH-SBFD may indicate time length for guard period for |
| | two adjacent PO in time domain. |
| ♦ | msgA-HoppingBits-SBFD and msgA-IntraSlotFrequencyHopping-SBFD, |
| | wherein the msgA-HoppingBits-SBFD may indicate the frequency hopping size |
| | for the SBFD time unit; and the msgA-IntraSlotFrequencyHopping-SBFD may |
| | indicate whether the intraslot frequency hopping is enabled in the SBFD time unit. |
| ♦ | msgA-MCS-SBFD: the configured value can be 0~12; wherein the |
| | msgA-MCS-SBFD may indicate the order of MCS in the SBFD time unit. |
| ♦ | msgA-DMRS-Config-SBFD, wherein msgA-DMRS-Config-SBFD may indicate |
| | the demodulation reference signal (DMRS) configuration for the SBFD time unit. |

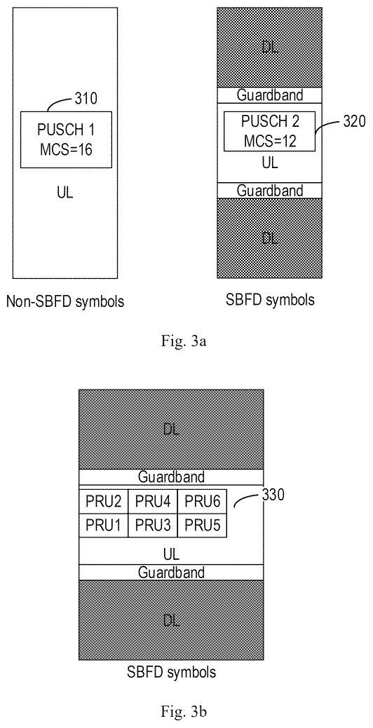

Alternatively, in a second candidate manner, the PUSCH configuration may indicate the second PRU set within the non-SBFD time unit. The PUSCH configuration may further include at least one offset value. Then, the terminal device 110 may determine the first PRU set based on the second set and the at least one offset value, such that the first PRU set can be located within a first subband for a first link direction, for example, a frequency subband for UL direction. Only for illustration purposes, PUSCH configuration with the offset value is further discussed with reference to FIG. 3a.

FIG. 3a illustrates examples of first PRU set for SBFD time units and second PRU set for non-SBFD time units according to some embodiments of the present disclosure.

As shown in FIG. 3a, in an example, some offset value relative to the non-SBFD symbols can be predefined or configured or indicated for UE PUSCH transmission on the SBFD symbols. The offset value may be configured for adjusting the second PRU set to determine a PRU set which is located within a frequency subband of the SBFD time unit, upon determining the first PRU set for the SBFD time unit. In an example, the offset value may be a frequency offset value relative to the frequency position of the second PRU set or an MCS offset relative to the MCS order for the second PRU set. Without any limitation, the at least one offset value may be any other value for determining the first PRU set.

Accordingly, by means of the above offset value(s) and the second PRU set, the terminal device 110 may determine first PRU set for the PUSCH transmissions on SBFD symbols. As shown in FIG. 3a, a MCS offset value can be predefined or configured for PUSCH of the msgA in the two-step random access procedure. The MCS offset value may be used for UE to determine the MCS of the MSGA PUSCH transmitted on the SBFD symbols. Furthermore, the above second PRU set may be within the non-SBFD time unit previous to the SBFD time unit. That is, the MCS value offset is relative to the latest transmitted PUSCH on the non-SBFD symbols. In this way, the inter/intra-subband cross link interference (CLI) influence may be also reduced. If the MCS of the latest transmitted PUSCH 310 on non-SBFD symbols is M, and the predefined or configured MCS offset value is N, then the MCS for msgA PUSCH 320 transmitted on the SBFD symbols is M-N. In the example, the latest transmitted PUSCH is configured PUSCH with the MCS=16, and the predefined MCS offset for MSGA PUSCH is 4, then the MCS applied to the msgA PUSCH transmission on the SBFD symbols is 12.

Returning back to FIG. 2, in a third candidate manner, the first PRU set and the second PRU set may be indicated separately. In some embodiments, the terminal device 110 may receive the PUSCH configuration by receiving a SBFD PUSCH configuration and a non-SBFD PUSCH configuration. The SBFD PUSCH configuration may indicate the first PRU set and the non-SBFD PUSCH configuration may indicate the second PRU set. Moreover, the SBFD PUSCH configuration may be configured independently from the non-SBFD PUSCH configuration. In this way, MsgA PUSCH configurations are determined for SBFD symbols and non-SBFD symbols separately. Similarly to the first candidate manner, the configured candidate value for some parameters of the SBFD PUSCH configuration may be smaller than that for the non-SBFD symbols. This embodiment may be also expressed as below:

A new IE(such as MsgA-PUSCH-Config-SBFD-r19 or
MsgA-PUSCH-Resource-SBFD-r19) can be defined for MsgA-PUSCH resource allocation
on SBFD symbols and this configuration can be included in the SIB1. Below parameters
can be included in the MsgA-PUSCH-Resource-SBFD IE. If UE transmit PUSCH on the
SBFD symbols then UE follow the PUSCH configuration in
MsgA-PUSCH-Resource-SBFD, and if UE transmit PUSCH on non-SBFD symbols then
UE transmit the PUSCH according to the MsgA-PUSCH-Resource configuration.

| | |
|---|---|
| MsgA-PUSCH-Resource-SBFD-r19 ::= | SEQUENCE { |
| msgA-MCS-SBFD | INTEGER (0..12), |
| nrofSlotsMsgA-PUSCH-SBFD | INTEGER (1..4), |
| profMsgA-PO-PerSlot-SBFD | ENUMERATED {one, |

two, three, six},

| | |
|---|---|
| msgA-PUSCH-TimeDomainOffset-SBFD | INTEGER (1..32), |
| msgA-PUSCH-TimeDomain Allocation-SBFD | INTEGER |

(1..maxNrofUL-Allocations)

| | |
|---|---|
| startSymbolAndLengthMsgA-PO-SBFD | INTEGER (0..127) |
| mappingTypeMsgA-PUSCH-SBFD | ENUMERATED |

{typeA, typeB}

| | |
|---|---|
| guardPeriodMsgA-PUSCH-SBFD | INTEGER (0..3) |
| guardBandMsgA-PUSCH-SBFD | INTEGER (0..1), |
| frequencyStartMsgA-PUSCH-SBFD | INTEGER |

(0..maxNrofPhysicalResourceBlocks-1),

| | |
|---|---|
| nrofPRBs-PerMsgA-PO-SBFD | INTEGER (1..16), |
| nrofMsgA-PO-FDM-SBFD | ENUMERATED {one, |

two, four},

| | |
|---|---|
| msgA-IntraSlotFrequencyHopping-SBFD | ENUMERATED {enabled} |
| msgA-HoppingBits-SBFD | BIT STRING (SIZE(2)) |

MsgA-DMRS-Config-r16,
wherein the nrofSlotsMsgA-PUSCH-SBFD may indicate the number of slots for the first
message; the startSymbolAndLengthMsgA-PO-SBFD may indicate the starting symbol and
the number of symbols for a PO; frequencyStartMsgA-PUSCH-SBFD may indicate the
starting PRB for the lowest PO; the PRBs-PerMsgA-PO-SBFD may indicate the number of
PRBs for a PO. In addition, the other parameters may be defined in the same way as
above.

In a fourth candidate manner, the PUSCH configuration may indicate another common set of parameters (which may be also referred to “the second common set of parameters”) that is differently defined for to the SBFD time unit(s) or non-SBFD time unit(s). In some embodiments, in the case that the terminal device 110 is to transmit the PUSCH on a SBFD time unit, resources indicated by the second common set of parameters are adjusted based on a frequency subband for a first link direction of the SBFD time unit, such that the resources for the first PRU set are located within the frequency subband. For example, in the case the terminal device 110 is to transmit the PUSCH in the non-SBFD time unit, the starting RB index of the second common set of parameters may be defined as the starting RB index of the bandwidth part (BWP) for the terminal device 110. In turn, in the case the terminal device 110 is to transmit the PUSCH in the SBFD time unit, the starting RB index of the second common set of parameters may be defined as the starting RB index of a frequency subband (for example, UL subband) for the terminal device 110. Only for illustration purposes, the fourth candidate manner is further discussed with reference to FIG. 3b.

FIG. 3b illustrates an example of first PRU set for SBFD time units according to some embodiments of the present disclosure. As mentioned above, the PRU and PO may be used interchangeably. The embodiments related to FIG. 3b are mainly discussed by using term “PO”.

For PUSCH configuration of SBFD symbols, some parameter definition can be revised or some configuration condition should be met no matter these parameters are separately configured or not. In an example, the definition of startSymbolAndLengthMsgA-PO is changed from relative to the starting index of symbols for the first message to relative to the starting index of SBFD symbols. That is, the network device 120 should ensure that the PUSCH time duration does not cross the boundary of the SBFD symbols and non-SBFD symbols. For SBFD symbols, the definition of frequencyStartMsgA-PUSCH is changed from relative to the starting of bandwidth part (BWP) to relative to the starting of the UL subband. In this case, the indicated PRU set (i.e., the first PRU set) should not fall into DL subband or guardband BW of the SBFD time unit. In addition or alternatively, for SBFD symbols, msgA-IntraSlotFrequency Hopping always disabled. Alternatively, the above embodiments may be also expressed as below:

```
For SBFD symbols, UE expect that the configured POs are within UL subband BW. That is
the configured value for frequencyStartMsgA-PUSCH , nrofPRBs-PerMsgA-PO and
nrofMsgA-PO-FDM should meet the below conditions.
    frequencyStartMsgA-PUSCH + nrofPRBs-PerMsgA-PO *SCS value of PUSCH*
nrofMsgA-PO-FDM <=UL subband BW.
  Or
  frequencyStartMsgA-PUSCH + guardBandMsgA-PUSCH*( nrofMsgA-PO-FDM-1)
<=UL subband BW.
The definition of these parameters may be defined in the same way as above.
```

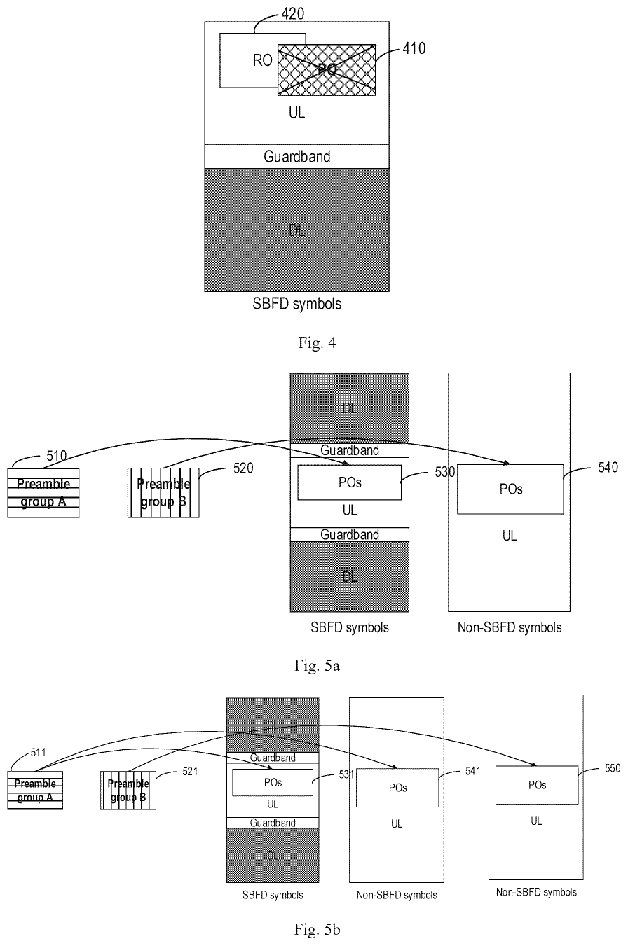

Returning back to FIG. 2, in addition, the terminal device 110 may determine whether the configured PRU set is valid. For example, if the configured first PRU set overlaps with the frequency subband for DL of the SBFD time units, this PRU set may be determined as invalid since the terminal device 110 cannot transmit PUSCH in DL subband. In some embodiments, the terminal device 110 may determine whether at least one PRU of the first PRU set is located within a frequency subband for a first link direction of the SBFD time unit and the at least one PRU not overlaps with a physical random access channel occasion (RO) for transmitting a random access channel. If the at least one PRU is located within the frequency subband and the at least one PRU not overlaps with the RO, the terminal device 110 may determine that the at least one PRU is valid. Only for illustration purposes, the determination of the valid of the PRU set is further discussed with reference to FIG. 4.

FIG. 4 illustrate an example of the determination of invalid PO according to some embodiments of the present disclosure.

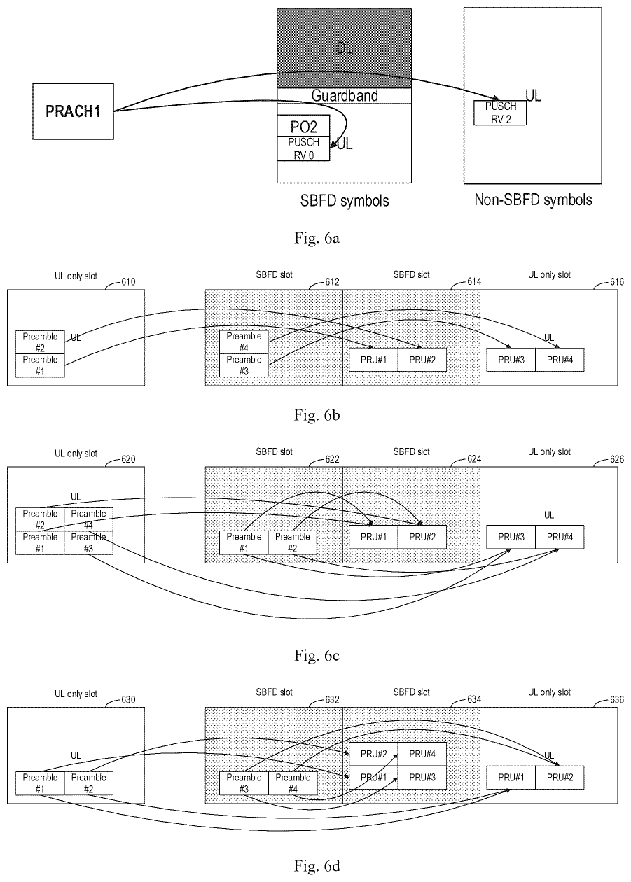

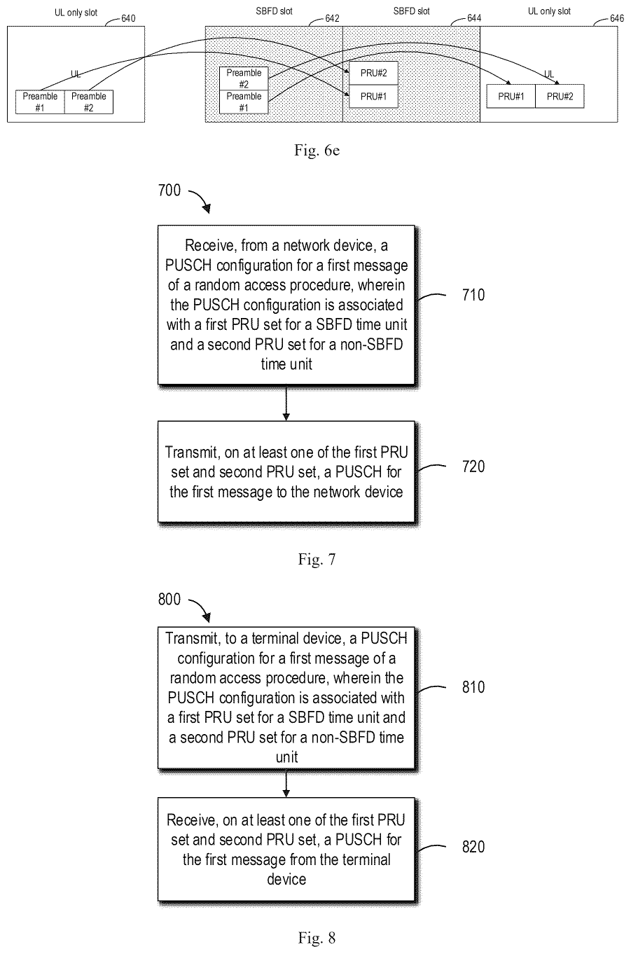

As shown in FIG. 4, the first PRU set (i.e., PO 410 as shown in FIG. 4) is located within the UL frequency subband of the SBFD symbols and partially overlaps with the RO 420. In an example, only fulfilling the below conditions, the PRU may be considered as valid, and the terminal device 110 may transmit the PUSCH according to the mapping relationship with PRACH (which may be further discussed with reference to FIGS. 5a-6e):
the PO is valid, if the PO within the UL subband in the SBFD symbols and the PO not overlaps with a preamble of valid PRACH occasions in the SBFD symbols.

Alternatively, this embodiment may be also expressed as below:

| | |
|---|---|
| ♦ | Below revision can be made for TS 38.213 section 8.2. |
| - | if a UE is provided tdd-UL-DL-ConfigurationCommon (wherein the |

tdd-UL-DL-ConfigurationCommon may indicate the frequency subband configuration for a
SBFD time unit.), a PUSCH occasion is valid if the PUSCH occasion

| | |
|---|---|
| | - is within UL symbols, or within UL subband in SBFD symbols. |
| ♦ | Such as in the right figure, the PO is overlapped with PRACH resource on |

the SBFD symbols, then this PO is considered invalid PO.

| | |
|---|---|
| ♦ | And if the PUSCH slot is a SBFD slot, if the PO frequency position exceed |

the UL subband edge, then this PO is invalid. That is only the PO within the UL subband,
then it is valid. If common PO configuration is given for SBFD symbols and non-SBFD
symbols, then if a PUSCH occasion overlapped with DL subband/guardband it can be
considered as invalid PO, and UE would not transmit PUSCH overlapped with DL
subband/guardband.

It is to be understood that, the above candidate manners can be also implemented in any combination way for indicating the first and second PRU sets without any limitation.

Returning back to FIG. 2, as mentioned above, in the first message of the random access procedure, the PRACH may have a preamble that is associated with or mapped to a PRU for the same Message 1 or Message A. In an example, there may be two group of preambles (for example, a first group of preambles and second group of preambles) and two group of PRUs (for example, a first group of PRUs and second group of PRUS). In this case, a first preamble from the first group of preambles is associated with a first PRU from the first group of PRUS. A second preamble from second first group of preambles is associated with a second PRU from the second group of PRUs. Furthermore, PRUs in the second group of PRUs may be allocated with more resources than that of PRUs in the first group of PRUs. In turn, if the terminal device is to transmit a large amount of data, the terminal device 110 may use the second preamble for transmitting the PRACH. Otherwise, the terminal device 110 may use the first preamble for transmitting the PRACH. Then, the terminal device 110 may transmit the first message by transmitting the PRACH having a preamble and transmitting a PUSCH on the PRU which the preamble is associated with.

With the introduction of the SBFD time unit, the above association may be further enhanced. In other words, based on determining that a preamble is in a first group of preambles or second group of preambles, the terminal device 110 will determine (227) a PRU group with respect to the first and/or second PRU set for transmitting the corresponding PUSCH, this PRU is associated with the above preamble.

In some embodiments, the above first group of PRUs may correspond to the first PRU set and the second group of PRUs may correspond to the second PRU set. Because the second PRU set may have more frequency resources. That is, a preamble of the first group of preambles is mapped to a PRU of the first PRU set, and wherein another preamble of the second group of preambles is mapped to another PRU of the second PRU set. In other words, the first group of preambles is associated with the first PRU set, and the second group of preambles is associated with the second PRU set. Only for illustration purposes, the association between preambles and PRUs of the first and second PRU set is further discussed with reference to FIG. 5a.

FIG. 5a illustrates an example of the association between a preamble group and a PO group according to some embodiments of the present disclosure.

As mentioned above, two groups of preambles and two PUSCH resource configurations are configured for the SBFD aware UE. Then, the association relationship for PRACH and the PUSCH can be changed as below: the preamble group A (which may be the first group of preambles) may be associated with the PUSCH resource on the SBFD symbols; and preamble group B (which may be the second group of preambles) may be associated with the PUSCH resource on the non-SBFD symbols. Moreover, the mapping may be separately performed for each group. As shown in FIG. 5a, the preamble group A 510 may be associated with PRUs 530 in the first PRU set, and the preamble group B 520 may be associated with PRUs 540 in the second PRU set.

In addition, for each group, the preambles are mapped to the PRU in increasing order of time resource indexes t_id for time multiplexed PUSCH occasions within a PUSCH slot on the SBFD symbols or non-SBFD symbols. Alternatively, PRUs of the first PRU set on SBFD symbols may be configured as the resource in msgA-PUSCH-ResourceGroupA, and the PRUs of the second PRU set on non-SBFD symbols is configured as the resource in msgA-PUSCH-ResourceGroupB. Without any limitation, the msgA-PUSCH-ResourceGroupA may be the first group of preambles or preamble group A as mentioned above, The msgA-PUSCH-ResourceGroupB may be the second group of preambles or preamble group B as mentioned above.

Returning back to FIG. 2, alternatively, a first preamble of the first group of preambles may be mapped to a first PRU of the first PRU set. A second preamble of the first group of preambles may be mapped to a second PRU of the second PRU set, and the second preamble may be same as or different from the first preamble. That is, the preamble from the first group of preambles may be associated with PRU of the first PRU set and/or another PRU of the second PRU set. In addition, a third preamble of the second group of preambles may be associated with a third PRU of the second PRU set. Only for illustration purposes, this association is further discussed with reference to FIG. 5b.

FIG. 5b illustrates an example of the association between a preamble group and a PO group according to some embodiments of the present disclosure.

As shown in FIG. 5b, a part of the preamble group A 511 is associated with the PRUs of the first PRU set on the SBFD symbols and/or may be also associated with PRUs of the second PRU set on the non-SBFD symbols. In addition or alternatively, another part the preamble group A 511 is associated with PRUs of the second PRU set on the non-SBFD symbols. The preamble group B 520 is associated with PRUs of the second PRU set on the non-SBFD symbols. In an example, the preamble group A 511 may be associated with the PUSCH resource on the SBFD symbols and some PUSCH resource on the non-SBFD symbols. The preambles group B may be associated with the left PUSCH resource on the non-SBFD symbols. In addition, the association relationships are separately performed for each group. In this case, in the association between preambles and PRUs, the PRU index for PRU of the first PRU set is associated in an increasing order of slot indexes for the SBFD slots and non-SBFD slots. In addition, the PRU index for PRU of the second PRU set is associated in an increasing order of slot indexes for other configured non-SBFD slots. In turn, the network device 120 may configure the PUSCH resource group A including the PRUs of the first PRU set on SBFD slot and PRUs of the second PRU set on a part of the non-SBFD slot, and configure the PUSCH resource group B including the PRUs of the second PRU set on the non-SBFD slot.

Returning back to FIG. 2, in the case that the associations between the groups of preambles and the PRUs in the first and second PRU sets are determined, for actually transmitting a first message, the terminal device 110 may map (229) the preamble in each group of preambles to a PRU based on a mapping criterion. Regarding the mapping criterion, the terminal device 110 may map the preamble in the existing rule (for example, based on the increasing order of the PRU index as mentioned above). Alternatively, since the preamble of the PRACH may be also transmitted in the SBFD time units, there may be also further several alternative approaches for mapping the preamble in each group of preambles to a PRU.

In some embodiments, the preamble of the transmitted PRACH may be mapped to both a PRU in the SBFD time unit and another PRU in the non-SBFD time unit. In this case, a PRACH for the first message is mapped to a PUSCH transmitted on a PRU of the first PRU set and another PUSCH transmitted on another PRU of the second PRU set. In addition, the terminal device 110 may transmit the PUSCH having a data transport block on the PRU and the other PUSCH having the same data transport block on the other PRU. Furthermore, a first redundancy version for the data transport block on the PRU is different from a second redundancy version for the same data transport block on the other PRU. In this way, the PUSCH for the first message may be enhanced in the terms of the reliability and coverage. Only for illustration purposes, the preamble of the PRACH mapped to PRUs in the SBFD time unit and non-SBFD time unit is further discussed with reference to FIG. 6a.

FIG. 6a illustrates an example of the mapping criteria between the preambles in SBFD or non-SBFD time units and PRUs in SBFD or non-SBFD time units according to some embodiments of the present disclosure.

As shown in FIG. 6a, one PRACH is separately mapped to two PUSCHs on SBFD symbols and non-SBFD symbols. The terminal device may transmit two PUSCHs after PRACH on the SBFD symbols and non-SBFD symbols respectively. These two PUSCHs can carry the same transport block with different redundancy versions (RV), and the RV number may be predefined. In the example, the PUSCH1 transmitted on the SBFD symbols carries the RV number 0, and the PUSCH2 transmitted on the non-SBFD symbols carries the redundancy version number 2.

Returning back to FIG. 2, alternatively, in some embodiments, for mapping preambles to the PRUs in the first and/or second PRU set, each group of preambles (for example, the first group of preambles or second group of preambles) may be divided into a third group of preambles transmitted on the SBFD time unit(s) and a fourth group of preambles transmitted on the non-SBFD time unit(s). Then, the terminal device may map the preamble of the PRACH to the PRU based on the mapping rules between the third and fourth groups of preambles and the first and second PRU sets. Without any limitation, in some further embodiments, the mapping is performed between a group of preambles and a part of the first and second PRU sets, and the group of preambles is associated with the part (as discussed above in FIGS. 5a and 5b). Accordingly, the mapping between the third and fourth groups of preambles and the above part of the first and second PRU sets may be performed in the same way. That is, the above part of the first and second PRU sets is also divided into a third PRU set on the SBFD time units and a fourth PRU set on the non-SBFD time units. Then, the mapping is performed between the third group or four group of preambles and the third or fourth PRU set. In the example as discussed in FIG. 5b, the first group of preambles is associated with both the first and second PRU sets. Then, the associated part of the first and second PRU sets is further divided into third and fourth PRU sets. In turn, the mapping between the first group of preambles and the associated part may be performed by the following embodiments. Only for discussion simplicity, the following embodiments are discussed based on the third and fourth groups of preambles, and the first and second PRU sets.

In some embodiments, indices of the preambles in the third preamble group and fourth preamble group are numbered uniformly. That is, the preambles in the SBFD time units and the preambles in the non-SBFD time units are uniformly numbered. The first PRU set and the second PRU set are configured to locate at the same frequency resource location in different time units (for example, in the SBFD time unit and non-SBFD time unit). The indices of PRUs in the first PRU set and second PRU set are numbered uniformly. In this case, the mapping between preambles and PRUs are performed commonly. Specifically, the same mapping ratio is determined based on a first number of the preambles (in the third preamble group and fourth preamble group) and a second number of the PRUs (in the first PRU set and second PRU set). Only for illustration purposes, this mapping manner is further discussed with reference to FIG. 6b.

FIG. 6b illustrates an example of the mapping criteria between the preambles in SBFD or non-SBFD time units and PRUs in SBFD or non-SBFD time units according to some embodiments of the present disclosure.

As shown in FIG. 6b, the MsgA PUSCH configuration is common for SBFD symbols and non-SBFD symbols. The indices for preambles of PRACH are numbered for SBFD symbols and non-SBFD symbols uniformly, and the indices for the PRU in the first PRU set and second PRU set are numbered for SBFD symbols and non-SBFD symbols uniformly. For example, the indices may be numbered in an increasing order of slot indices. Then, the preambles of PRACH (no matter on SBFD time unit or non-SBFD time unit) are commonly mapped to PRUs on SBFD symbols and non-SBFD using the mapping procedure mentioned as above. In FIG. 6b, the preambles #1, the preambles #2, the preambles #3 and the preambles #4 in the non-SBFD time unit 610 and SBFD time unit 612 are mapped to PRU #1, PRU #2, PRU #3 and PRU #4 in SBFD time unit 614 and non-SBFD time unit 616 by the same mapping ratio.

In an example, the mapping ratio is ceil (T “preamble”/T_“PUSCH”), T_“preamble” is a total number of valid PRACH occasions in SBFD symbols and non-SBFD symbols per association pattern period multiplied by the number of preambles per valid PRACH occasion provided by rach-ConfigCommonTwoStepRA. T_“PUSCH” is a total number of valid PUSCH occasions in SBFD symbols and non-SBFD symbols per PUSCH configuration per association pattern period multiplied by the number of DMRS resource indexes per valid PUSCH occasion provided by msgA-DMRS-Config. As shown in FIG. 6b, the mapping ratio is 1. Then, each RO in SBFD symbols or non-SBFD symbols is mapped to one PRU in the SBFD symbols or non-SBFD symbols.

Returning back to FIG. 2, alternatively, the indices of the preambles in the third preamble group are numbered independently from the indices of the preambles in the fourth preamble group. That is, the preambles in the SBFD time units are numbered independently from the preambles in the non-SBFD time units. In addition, the first PRU set and the second PRU set are configured to locate at the same frequency resource location in different time units (for example, in the SBFD time unit and non-SBFD time unit). The indices of PRUs in the first PRU set and second PRU set are numbered uniformly. In this case, a first mapping and a second mapping for the preambles and PRUs are separately performed. The first mapping is between the preambles in the third preamble group and the PRUs in the first and second PRU sets, and the second mapping is between the preambles in the fourth preamble group and the PRUs in the first PRU and second PRU sets. In this way, different beams can be used for PUSCHs on SBFD symbols and non-SBFD symbols. Only for illustration purposes, the first mapping and second mapping are further discussed with reference to FIG. 6c.

FIG. 6c illustrates another example of the mapping criteria between the preambles in SBFD or non-SBFD time units and PRUs in SBFD or non-SBFD time units according to some embodiments of the present disclosure.

As shown in FIG. 6c, the preamble #1, preamble #2, preamble #3, preamble #4 for the non-SBFD symbols 620 and the preamble #1, preamble #2 for the SBFD symbols 622 are separately numbered. The PRU #1, PRU #2, PRU #3 and PRU #4 for SBFD symbols 624 and non-SBFD symbols 626 are numbered uniformly. The PRU #1, PRU #2, PRU #3 and PRU #4 are configured by the same Msg A PUSCH configuration. In this case, the preambles for SBFD time units and other preambles for non-SBFD time units are separately mapped to PRU.

In a specific example of FIG. 6c, the PRACH configuration for the SBFD symbols and the PRACH configuration for the non-SBFD symbols may be separately performed. In a non-SBFD PRACH slot, there are four ROs. In an SBFD PRACH slot, there are two ROs. Moreover, the msgA PUSCH configuration for SBFD slot and non-SBFD slot are common. In this case, the first mapping between the PRACH on the SBFD slot and the PRUs are performed independently from the PRACH on the non SBFD slot. RO #1~RO #4 on the non-SBFD slot are mapped to PRU #1~PRU #4 on the SBFD slot and non-SBFD slot. In turn, RO #1 on SBFD slot are mapped to PRU #1 and PRU #2, and RO #2 on SBFD slot are mapped to PRU #3 and PRU #4.

Returning back to FIG. 2, alternatively, the indices of the preambles in the third preamble group and fourth preamble group are numbered uniformly. That is, the preambles in the SBFD time units and the preambles in the non-SBFD time units are numbered uniformly. In addition, the indices of PRUs in the first PRU set are numbered independently from indices of PRUs in the second PRU set. In this case, a third mapping and a fourth mapping for the preambles and PRUs are separately performed. The third mapping is between the preambles in the third and fourth preamble groups and PRUs in the first PRU set. The fourth mapping is between the preambles in the third and fourth preamble groups and PRUs in the second PRU set. In this way, the PUSCH resource for the first message may be reused, such that the latency for MsgA PUSCH can be reduced. Only for illustration purposes, the third mapping and fourth mapping are further discussed with reference to FIG. 6d.

FIG. 6d illustrates a further example of the mapping criteria between the preambles in SBFD or non-SBFD time units and PRUs in SBFD or non-SBFD time units according to some embodiments of the present disclosure.

As shown in FIG. 6d, the preamble #1, the preamble #2 for the non-SBFD time unit 630 and the preamble #3, the preamble #4 for the SBFD time unit 632 are configured commonly and are numbered uniformly. The PRU #1, PRU #2, PRU #3, PRU #4 for the SBFD time unit 634 are numbered independently from the PRU #1, PRU #2 for the non-SBFD time unit 636. That is, the preambles on SBFD slot and non-SBFD slot are uniformly configured. The PRUs on SBFD slot and non-SBFD slot are separately configured. Furthermore, the PRU are frequency division multiplexed (there are two FDM PRU) in one SBFD time unit. In this case, the third mapping and the fourth mapping is separately performed for the PRUs on the SBFD slot and non-SBFD slot. In this example, the mapping ratio is 1 for the PRUs on the SBFD slot, and the mapping ratio is 2 for the PRUs on the non-SBFD slot. In this way, the latency for MsgA PUSCH can be also reduced. In addition or alternatively, the mapping procedure may be performed in an increasing order of indexes for N_s PUSCH only for SBFD slots or non-SBFD slots

Returning back to FIG. 2, alternatively, the indices of the preambles in the third preamble group are numbered independently from indices of the preambles in the fourth preamble group. The indices of PRUs in the first PRU set are numbered independently from indices of PRUs in the second PRU set. In this case, a fifth mapping and a sixth mapping for the preambles and PRUs are separately performed. The fifth mapping may be between preambles in the third preamble group and PRUs in the first PRU set. Alternatively, the fifth mapping may be also between preambles in the third preamble group and PRUs in the second PRU set. The sixth mapping may be between preambles in the fourth preamble group and PRUs in the second PRU set. Alternatively, the sixth mapping may be also between preambles in the fourth preamble group and PRUs in the first PRU set. Only for illustration purposes, the fifth and sixth mappings are further discussed with reference to FIG. 6e.

FIG. 6e illustrates a yet example of the mapping criteria between the preambles in SBFD or non-SBFD time units and PRUs in SBFD or non-SBFD time units according to some embodiments of the present disclosure.

As shown in FIG. 6e, the preamble #1, preamble #2 in the non-SBFD time unit 640 are numbered independently from the preamble #1, preamble #2 in the SBFD time unit 642. Similarly, the PRU #1, PRU #2 in the SBFD time unit 644 are numbered independently from the PRU #1, PRU #2 in the non-SBFD time unit 646. Alternatively, the preambles in the SBFD time unit may be also considered as the first group of preambles. The preambles in the non-SBFD time unit may be also considered as the second group of preambles. In this case, the fifth mapping and the sixth mapping may be performed by the following:

SBFD PRACH can be considered as preamble group A, and the non-SBFD PRACH can be
considered as preamble group B. The mapping procedure in 38.213 can be changed to:
- third, in increasing order of time resource indexes for time multiplexed PRACH
occasions within a PRACH slot on SBFD slot or non-SBFD slot.

In the example of FIG. 6e, both the RACH and PUSCH are separately configured for SBFD slot and non-SBFD slot, and the preambles in the UL-only slot may be mapped to the PRUs on the SBFD slot, and the preambles in the SBFD slot may be mapped to the PRUs on the non-SBFD slot. Alternatively, the preambles in the UL-only slot may be mapped to the PRUs on the non-SBFD slot, and the preambles in the SBFD slot are mapped to the PRUs on the SBFD slot.

Returning back to FIG. 2, the terminal device 110 transmits (230) the PUSCH 235 on at least one of the first PRU set and second PRU set to the network device 120. In some embodiments, the terminal device 110 may transmit the PUSCH by transmitting the first message including the PUSCH 235 and the PRACH associated with the PUSCH 235. In turn, the network device 120 receives (240) the PUSCH 235.

As mentioned above, the power ramping operations for retransmitting the PRACH may be adjusted in view of the characteristics of the SBFD operations. In some embodiments, in order to reduce the CLI level in the SBFD time units, the power ramping steps may be separately configured for the PRACH and the PUSCH in the first message. In an example, the terminal device 110 may retransmit (241) a PRACH for the first message 243 based on a first power ramping step and retransmit a PUSCH on a PRU of the second PRU set based on a second power ramping step. The first power ramping step may be different from the second power ramping step. In addition, the terminal device 110 may retransmit (241) a PRACH for the first message 243 based on a third power ramping step and retransmit a PUSCH on a PRU of the first PRU set based on a fourth power ramping step. The third power ramping step may be different from the fourth power ramping step.

In addition or alternatively, the terminal device 110 may retransmit (241) a PRACH for the first message 243 based on a first power ramping counter and retransmit a PUSCH on a PRU of the second PRU set based on a second power ramping counter. The first power ramping counter may be different from the second power ramping counter. In addition, the terminal device 110 may retransmit (241) a PRACH for the first message 243 based on a third power ramping counter and retransmit a PUSCH on a PRU of the first PRU set based on a fourth power ramping counter. The third power ramping counter may be different from the fourth power ramping counter.

In a specific example, the powerRampingStep can be separately configured and different counters can be used for MsgA (re) transmission on SBFD symbols and non-SBFD symbols. The powerRampingStep may indicate a increasing power step between two continuous Msg A retransmissions. That is, a first MsgA (re) transmitted on SBFD symbols may be configured with a first powerRampingStep, and a second MsgA (re) transmitted on non-SBFD symbols may be configured with a second powerRampingStep. The first powerRampingStep can have a value different from the second power RampingStep. In addition or alternatively, as mentioned above, the PRACH and the PUSCH for the Msg A may be transmitted on different time units, such as the PRACH is transmitted on SBFD time units, and the PUSCH is transmitted on non-SBFD symbols. In this case, different powerampingstep can be configured for the PRACH and PUSCH. For example, one powerampingstep configurations for the PRACH and PUSCH are separately determined for SBFD symbols and non-SBFD symbols.

In addition or alternatively, different powerramping counters can be used for PRACH and PUSCH. Without any limitation, once the power ramping counter has expired, the terminal device 110 may use another beam for retransmitting the Msg A and resetting the power ramping counter. Alternatively, the terminal device 110 may still use the same beam while keeping the power ramping counter unchanged. In this case, different power counters can be used for PRACH and PUSCH especially they transmitted on different slot type to ensure the PRACH/PUSCH transmitted on the SBFD symbols will not produce CLI to the other UE for inter-subband duplex operation. In another example, if the PUSCH is retransmitted on the SBFD symbols, the power ramping counter may be suspended. Alternatively, if the retransmission time of the PUSCH on the SBFD symbols reaches a threshold, then power ramping counter +1. In turn, the network device 120 may receive (245) the first message retransmissions 243 accordingly.

Returning back to FIG. 2, in some cases, if the number of retransmissions for the first message is above a certain number, the 2-step random access procedure may fallback to a 4-step random access procedure. Similarly, the fallback procedure may be also adjusted with respect to the SBFD time units.

In some embodiments, a first retransmission number threshold is configured for retransmitting the first message on the SBFD time unit. A second retransmission number threshold is configured for retransmitting the first message on the non-SBFD time unit. In this case, if determining (246) that a number of retransmissions for the first message on the SBFD time unit is above the first retransmission threshold number, the terminal device 110 may fallback (248) the random access procedure to a four-step random access procedure. Correspondingly, if determining (246) that a number of retransmissions for the first message on the non-SBFD time unit is above the second retransmission threshold number, the terminal device 110 may fallback (248) the random access procedure to a four-step random access procedure. In this disclosure, the Msg A transmitted on the SBFD time unit may refer to the Msg A which comprises at least one of the PRACH or PUSCH A transmitted on the SBFD time unit.

In the specific example, the msgA retransmission times threshold configuration in SIB that trigger the 2-step RACH switch/fallback to 4-step RACH should consider the CLI influence to msgA transmission. Two separate values for msgA retransmission times threshold can be configured. One value is used for at least one time (the PRACH or PUSCH) of the msgA transmission on SBFD symbols, the other value is used for the case that all the msgA transmission (the PRACH and the PUSCH) on non-SBFD symbols. And the configured retransmission times threshold for the non-SBFD symbols may be larger than the value that is configured for MsgA transmitted on SBFD symbols.

In addition, if the preamble can be detected but the PUSCH is not decoded successfully on the SBFD symbols and the retransmission times reach the configured threshold, then the network device 120 can feedback a fallbackRAR. In this case, the terminal device 110 may transmit msg3 PUSCH on the non-SBFD symbols, that is 2-step RACH switch/fallback to 4-step RACH.

In addition, there is uplink resource reserved on at least one non-SBFD time unit. If determining that a number of retransmissions for the first message is above a fallback number threshold, the terminal device 110 may transmit the first message on the uplink resource. In other words, some resource on the UL slot can be reserved for UE to transmit the msgA PUSCH if the transmission failure times for MsgA PUSCH reach a predefined threshold.

In this way, the disclosure gives for configuring the PRUs (or PO) in SBFD symbols. The determination of the valid of the PRU (or PO) is considered. Besides, the association between PRUs (or PO) and preambles (or RO) is defined for the valid PRU in SBFD symbols. In addition, this disclosure further provided PO allocation/configuration in UL subband of SBFD symbols; valid PRU (or PO) determination on SBFD symbols; the mapping relationship between preamble (or RO) and PRU (or PO) in SBFD symbols; power control for PUSCH for MsgA; and 2-step RACH fallback to 4-step RACH.

FIG. 7 illustrates a flowchart of a method 700 of communication implemented at a terminal device in accordance with some embodiments of the present disclosure. The method 700 can be implemented at the terminal device 110 shown in FIG. 1. For the purpose of discussion, the method 700 will be described with reference to FIG. 1. It is to be understood that the method 700 may include additional acts not shown and/or may omit some shown acts, and the scope of the present disclosure is not limited in this regard.

At 710, the terminal device 110 receives, from a network device 120, a PUSCH configuration for a first message of a random access procedure. The PUSCH configuration is associated with a first PRU set for a SBFD time unit and a second PRU set for a non-SBFD time unit. The SBFD time unit is configured with frequency subbands for different link directions. At 720, the terminal device 110 transmits, on at least one of the first PRU set and second PRU set, a PUSCH for the first message to the network device 120.

In some embodiments, the random access procedure is a two-step random access procedure, and wherein the first message is a Msg A of the two-step random access procedure.

In some embodiments, the PUSCH configuration comprises a first common set of parameters, a SBFD set of parameters and a non-SBFD set of parameters, and wherein the terminal device may determine the first PRU set and second PRU set by: determining, based on the first common set of parameters and SBFD set of parameters, the first PRU set within the SBFD time unit; and determining, based on the first common set of parameters and non-SBFD set of parameters, the second PRU set within the non-SBFD time unit.

In some embodiments, a candidate configured parameter of the SBFD set of parameters comprises at least one of a first PRU number of frequency division multiplexed (FDM) PRUs in the SBFD time unit, a first resource block (RB) number for a PRU in the SBFD time unit, or a first modulation and coding scheme (MCS) order. A candidate configured parameter of the non-SBFD set of parameters comprises at least one of a second PRU number of FDM PRUs in the non-SBFD time unit, a second RB number for another PRU in the non-SBFD time unit, or a second MCS order. The maximum value of at least one candidate configured parameter of the SBFD set of parameters is smaller than another maximum value of at least one corresponding candidate configured parameter of the non-SBFD set of parameters.

In some embodiments, the PUSCH configuration indicates the second PRU set within the non-SBFD time unit and the PUSCH configuration comprises at least one offset value. The terminal device 110 may the first PRU set by: determining the first PRU set based on the second PRU set and the at least one offset value.

In some embodiments, the second PRU set is within the non-SBFD time unit previous to the SBFD time unit, and wherein the at least one offset value comprise a MCS offset value.

In some embodiments, the terminal device 110 may receive the PUSCH configuration by: receiving a SBFD PUSCH configuration indicating the first PRU set; and receiving a non-SBFD PUSCH configuration indicating the second PRU set, the SBFD PUSCH configuration being configured independently from the non-SBFD PUSCH configuration.

In some embodiments, the PUSCH configuration comprises a second common set of parameters, and in the case that the terminal device 110 is to transmit the PUSCH on a SBFD time unit, resources indicated by the second common set of parameters are adjusted based on a frequency subband for a first link direction of the SBFD time unit, such that the resources for the first PRU set are located within the frequency subband.

In some embodiments, the terminal device 110 may further determine whether at least one PRU of the first PRU set is located within a frequency subband for a first link direction of the SBFD time unit and the at least one PRU not overlaps with a random access channel occasion (RO) for transmitting a random access channel. The terminal device 110 may determine the at least one PRU as valid based on determining that the at least one PRU is located within the frequency subband and the at least one PRU not overlaps with the RO.

In some embodiments, the terminal device 110 may be configured with a plurality of preambles for a physical random access channel (PRACH), the plurality of preambles comprising a first group of preambles and a second group of preambles.

In some embodiments, a preamble of the first group of preambles is mapped to a PRU of the first PRU set, and wherein another preamble of the second group of preambles is mapped to another PRU of the second PRU set.

In some embodiments, a first preamble of the first group of preambles is mapped to a first PRU of the first PRU set, a second preamble of the first group of preambles is mapped to a second PRU of the second PRU set, the second preamble being the same as or different from the first preamble, and a third preamble of the second group of preambles is mapped to a third PRU of the second PRU set.

In some embodiments, a PRACH for the first message is associated with a PUSCH transmitted on a PRU of the first PRU set and another PUSCH transmitted on another PRU of the second PRU set. Terminal device 110 may further transmit the PUSCH having a data transport block on the PRU and the other PUSCH having the same data transport block on the other PRU, a first redundancy version for the data transport block on the PRU being different from a second redundancy version for the same data transport block on the other PRU.

In some embodiments, the plurality of preambles comprises a third preamble group for at least one SBFD time unit and a fourth preamble group for at least one non-SBFD time unit.

In some embodiments, the third preamble group and fourth preamble group are subgroups of the first preamble group or second preamble group.

In some embodiments, indices of the preambles in the third preamble group and fourth preamble group are numbered uniformly, based on the PUSCH configuration, the first PRU set and the second PRU set are configured to locate at the same frequency resource location in different time units, and indices of PRUs in the first PRU set and second PRU set are numbered uniformly, and the preambles in the third preamble group and fourth preamble group are mapped, by the same mapping ratio, to the PRUs in the first PRU set and second PRU set. The same mapping ratio is determined based on a first number of the preambles in the third preamble group and fourth preamble group and a second number of the PRUs in the first PRU set and second PRU set.

In some embodiments, indices of the preambles in the third preamble group are numbered independently from indices of the preambles in the fourth preamble group. Based on the PUSCH configuration, the first PRU set and the second PRU set are configured to locate at the same frequency resource location in different time units, and indices of PRUs in the first PRU set and second PRU set are numbered uniformly. A first mapping and a second mapping are separately performed. The first mapping is between the preambles in the third preamble group and the PRUs in the first and second PRU sets. The second mapping is between the preambles in the fourth preamble group and the PRUS in the first PRU and second PRU sets.

In some embodiments, indices of the preambles in the third preamble group and fourth preamble group are numbered uniformly, indices of PRUs in the first PRU set are numbered independently from indices of PRUs in the second PRU set, and a third mapping and a fourth mapping are separately performed. The third mapping is between the preambles in the third and fourth preamble groups and PRUs in the first PRU set, and the fourth mapping is between the preambles in the third and fourth preamble groups and PRUs in the second PRU set.

In some embodiments, indices of the preambles in the third preamble group are numbered independently from indices of the preambles in the fourth preamble group, indices of PRUs in the first PRU set are numbered independently from indices of PRUs in the second PRU set, and a fifth mapping and a sixth mapping are separately performed. The fifth mapping is between preambles in the third preamble group and PRUs in the first PRU set or between preambles in the third preamble group and PRUs in the second PRU set. The sixth mapping is between preambles in the fourth preamble group and PRUs in the second PRU set or between preambles in the fourth preamble group and PRUs in the first PRU set.

In some embodiments, the terminal device 110 may further retransmit a PRACH for the first message based on a first power ramping step and retransmit a PUSCH on a PRU of the second PRU set based on a second power ramping step, the first power ramping step being different from the second power ramping step; or retransmit a PRACH for the first message based on a third power ramping step and retransmit a PUSCH on a PRU of the first PRU set based on a fourth power ramping step, the third power ramping step being different from the fourth power ramping step.

In some embodiments, the terminal device 110 may further retransmit a PRACH for the first message based on a first power ramping counter and retransmit a PUSCH on a PRU of the second PRU set based on a second power ramping counter, the first power ramping counter being different from the second power ramping counter; or retransmit a PRACH for the first message based on a third power ramping counter and retransmit a PUSCH on a PRU of the first PRU set based on a fourth power ramping counter, the third power ramping counter being different from the fourth power ramping counter.

In some embodiments, a first retransmission number threshold is configured for retransmitting the first message on the SBFD time unit, and a second retransmission number threshold is configured for retransmitting the first message on the non-SBFD time unit. The terminal device 110 may further based on determining that a number of retransmissions for the first message on the SBFD time unit is above the first retransmission threshold number, fallback the random access procedure to a four-step random access procedure; or based on determining that a number of retransmissions for the first message on the non-SBFD time unit is above the second retransmission threshold number, fallback the random access procedure to a four-step random access procedure.

In some embodiments, an uplink resource is reserved on at least one non-SBFD time unit. The terminal device 110 may further based on determining that a number of retransmissions for the first message is above a fallback number threshold, transmit the first message on the uplink resource.

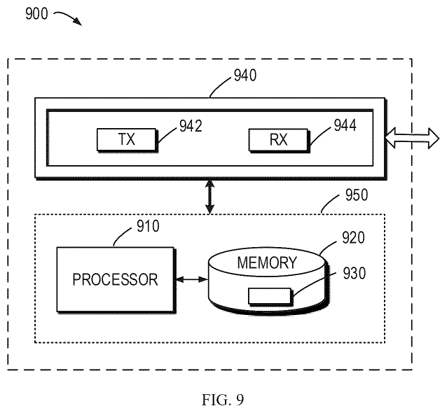

FIG. 8 illustrates a flowchart of a method 800 of communication implemented at a network device in accordance with some embodiments of the present disclosure. The method 800 can be implemented at the network device 120 shown in FIG. 1. For the purpose of discussion, the method 800 will be described with reference to FIG. 1. It is to be understood that the method 800 may include additional acts not shown and/or may omit some shown acts, and the scope of the present disclosure is not limited in this regard.

At 810, the network device 120 transmits, to a terminal device, a PUSCH configuration for a first message of a random access procedure. The PUSCH configuration is associated with a first PRU set for a SBFD time unit and a second PRU set for a non-SBFD time unit. The SBFD time unit is configured with frequency subbands for different link directions. Then, at 820, the network device 120 receives, on at least one of the first PRU set and second PRU set, a PUSCH for the first message to the network device.

In some embodiments, the random access procedure is a two-step random access procedure, and wherein the first message is a Msg A of the two-step random access procedure.

In some embodiments, the PUSCH configuration comprises a first common set of parameters, a SBFD set of parameters and a non-SBFD set of parameters.

In some embodiments, a candidate configured parameter of the SBFD set of parameters comprises at least one of a first PRU number of frequency division multiplexed (FDM) PRUs in the SBFD time unit, a first resource block (RB) number for a PRU in the SBFD time unit, a first modulation and coding scheme (MCS) order. A candidate configured parameter of the non-SBFD set of parameters comprises at least one of a second PRU number of frequency division multiplexed (FDM) PRUs in the non-SBFD time unit, a second resource block (RB) number for another PRU in the non-SBFD time unit, a second modulation and coding scheme (MCS) order. The maximum value of at least one candidate configured parameter of the SBFD set of parameters is smaller than another maximum value of at least one corresponding candidate configured parameter of the non-SBFD set of parameters.

In some embodiments, the PUSCH configuration indicates the second PRU set within the non-SBFD time unit and the PUSCH configuration comprises at least one offset value.

In some embodiments, the second PRU set is within the non-SBFD time unit previous to the SBFD time unit, and wherein the at least one offset value comprise a MCS offset value.

In some embodiments, the network device 120 may transmit the PUSCH configuration by: transmitting a SBFD PUSCH configuration indicating the first PRU set; and transmitting a non-SBFD PUSCH configuration indicating the second PRU set, the SBFD PUSCH configuration being configured independently from the non-SBFD PUSCH configuration.

In some embodiments, the PUSCH configuration comprises a second common set of parameters, and wherein resources indicated by the second common set of parameters are adjusted based on a frequency subband for a first link direction of the SBFD time unit, such that the resources for the first PRU set are located within the frequency subband.

In some embodiments, the network device 120 may further configure, to the terminal device, a plurality of preambles for a physical random access channel (PRACH), the plurality of preambles comprising a first group of preambles and a second group of preambles.

In some embodiments, a preamble of the first group of preambles is mapped to a PRU of the first PRU set, and wherein another preamble of the second group of preambles is mapped to another PRU of the second PRU set.

In some embodiments, a first preamble of the first group of preambles is mapped to a first PRU of the first PRU set, a second preamble of the first group of preambles is mapped to a second PRU of the second PRU set, the second preamble being the same as or different from the first preamble, and a third preamble of the second group of preambles is mapped to a third PRU of the second PRU set.

In some embodiments, a PRACH transmitted based on a preamble of the first group of preambles or second group of preambles is associated with a PUSCH transmitted on a PRU of the first PRU set and another PUSCH transmitted on another PRU of the second PRU set.

In some embodiments, the plurality of preambles comprises a third preamble group for at least one SBFD time unit and a fourth preamble group for at least one non-SBFD time unit. In some embodiments, the third preamble group and fourth preamble group are subgroups of the first preamble group or second preamble group.

In some embodiments, indices of the preambles in the third preamble group and fourth preamble group are numbered uniformly, based on the PUSCH configuration, the first PRU set and the second PRU set are configured to locate at the same frequency resource location in different time units, and indices of PRUs in the first PRU set and second PRU set are numbered uniformly, and the preambles in the third preamble group and fourth preamble group are mapped, by the same mapping ratio, to the PRUs in the first PRU set and second PRU set. The same mapping ratio being determined based on a first number of the preambles in the third preamble group and fourth preamble group and a second number of the PRUs in the first PRU set and second PRU set.

In some embodiments, indices of the preambles in the third preamble group are numbered independently from indices of the preambles in the fourth preamble group, based on the PUSCH configuration, the first PRU set and the second PRU set are configured to locate at the same frequency resource location in different time units, and indices of PRUs in the first PRU set and second PRU set are numbered uniformly, and a first mapping and a second mapping are separately performed. The first mapping is between the preambles in the third preamble group and the PRUs in the first and second PRU sets, and the second mapping is between the preambles in the fourth preamble group and the PRUs in the first PRU and second PRU sets.

In some embodiments, indices of the preambles in the third preamble group and fourth preamble group are numbered uniformly, indices of PRUs in the first PRU set are numbered independently from indices of PRUs in the second PRU set, and a third mapping and a fourth mapping are separately performed. The third mapping is between the preambles in the third and fourth preamble groups and PRUs in the first PRU set, and the fourth mapping is between the preambles in the third and fourth preamble groups and PRUs in the second PRU set.

In some embodiments, indices of the preambles in the third preamble group are numbered independently from indices of the preambles in the fourth preamble group, indices of PRUs in the first PRU set are numbered independently from indices of PRUs in the second PRU set, and a fifth mapping and a sixth mapping are separately performed, the fifth mapping is between preambles in the third preamble group and PRUs in the first PRU set or between preambles in the third preamble group and PRUs in the second PRU set, and the sixth mapping is between preambles in the fourth preamble group and PRUs in the second PRU set or between preambles in the fourth preamble group and PRUs in the first PRU set.

FIG. 9 is a simplified block diagram of a device 900 that is suitable for implementing some embodiments of the present disclosure. The device 900 can be considered as a further example embodiment of the terminal device 110 or network device 120 as shown in FIG. 1. Accordingly, the device 900 can be implemented at or as at least a part of the above network devices or terminal devices.

As shown, the device 900 includes a processor 910, a memory 920 coupled to the processor 910, a suitable transceiver 940 coupled to the processor 910, and a communication interface coupled to the transceiver 940. The memory 910 stores at least a part of a program 930. The transceiver 940 may be for bidirectional communications or a unidirectional communication based on requirements. The transceiver 940 may include at least one of a transmitter 942 and a receiver 944. The transmitter 942 and the receiver 944 may be functional modules or physical entities. The transceiver 940 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 930 is assumed to include program instructions that, when executed by the associated processor 910, enable the device 900 to operate in accordance with the embodiments of the present disclosure, as discussed herein with reference to FIGS. 1-8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

In some embodiments, a terminal device comprises circuitry configured to perform method 700.

In some embodiments, a network device comprises circuitry configured to perform method 800.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, technique terminal devices or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 2 to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

In summary, embodiments of the present disclosure may provide the following solutions.

A terminal device comprises a transceiver; and a processor communicatively coupled to the transceiver. The processor is configured to cause the terminal device to: receive, from a network device, a physical uplink shared channel (PUSCH) configuration for a first message of a random access procedure, wherein the PUSCH configuration is associated with a first PUSCH Resource Unit (PRU) set for a subband non-overlapping full duplex (SBFD) time unit and a second PRU set for a non-SBFD time unit, and wherein the SBFD time unit is configured with frequency subbands for different link directions; and transmit, on at least one of the first PRU set and second PRU set, a PUSCH for the first message to the network device.

In one embodiment, wherein the random access procedure is a two-step random access procedure, and wherein the first message is a message A (Msg A) of the two-step random access procedure.

In one embodiment, wherein the PUSCH configuration comprises a first common set of parameters, a SBFD set of parameters and a non-SBFD set of parameters, and wherein the terminal device is further caused to determine the first PRU set and second PRU set by: determining, based on the first common set of parameters and SBFD set of parameters, the first PRU set within the SBFD time unit; and determining, based on the first common set of parameters and non-SBFD set of parameters, the second PRU set within the non-SBFD time unit.

In one embodiment, wherein: a candidate configured parameter of the SBFD set of parameters comprises at least one of a first PRU number of frequency division multiplexed (FDM) PRUs in the SBFD time unit, a first resource block (RB) number for a PRU in the SBFD time unit, or a first modulation and coding scheme (MCS) order, a candidate configured parameter of the non-SBFD set of parameters comprises at least one of a second PRU number of FDM PRUs in the non-SBFD time unit, a second RB number for another PRU in the non-SBFD time unit, or a second MCS order, and the maximum value of at least one candidate configured parameter of the SBFD set of parameters is smaller than another maximum value of at least one corresponding candidate configured parameter of the non-SBFD set of parameters.

In one embodiment, wherein the PUSCH configuration indicates the second PRU set within the non-SBFD time unit and the PUSCH configuration comprises at least one offset value, and wherein the terminal device is further caused to determine the first PRU set by: determining the first PRU set based on the second PRU set and the at least one offset value.

In one embodiment, wherein the second PRU set is within the non-SBFD time unit previous to the SBFD time unit, and wherein the at least one offset value comprise a MCS offset value.

In one embodiment, wherein the terminal device is caused to receive the PUSCH configuration by: receiving a SBFD PUSCH configuration indicating the first PRU set; and receiving a non-SBFD PUSCH configuration indicating the second PRU set, the SBFD PUSCH configuration being configured independently from the non-SBFD PUSCH configuration.

In one embodiment, wherein: the PUSCH configuration comprises a second common set of parameters, and in the case that the terminal device is to transmit the PUSCH on a SBFD time unit, resources indicated by the second common set of parameters are adjusted based on a frequency subband for a first link direction of the SBFD time unit, such that the resources for the first PRU set are located within the frequency subband.

In one embodiment, wherein the terminal device is further caused to: determine whether at least one PRU of the first PRU set is located within a frequency subband for a first link direction of the SBFD time unit and the at least one PRU not overlaps with a random access channel occasion (RO) for transmitting a random access channel; and determine the at least one PRU as valid based on determining that the at least one PRU is located within the frequency subband and the at least one PRU not overlaps with the RO.

In one embodiment, wherein: the terminal device is configured with a plurality of preambles for a physical random access channel (PRACH), the plurality of preambles comprising a first group of preambles and a second group of preambles.

In one embodiment, wherein a preamble of the first group of preambles is mapped to a PRU of the first PRU set, and wherein another preamble of the second group of preambles is mapped to another PRU of the second PRU set.

In one embodiment, wherein: a first preamble of the first group of preambles is mapped to a first PRU of the first PRU set, a second preamble of the first group of preambles is mapped to a second PRU of the second PRU set, the second preamble being the same as or different from the first preamble, and a third preamble of the second group of preambles is mapped to a third PRU of the second PRU set.

In one embodiment, wherein a PRACH for the first message is associated with a PUSCH transmitted on a PRU of the first PRU set and another PUSCH transmitted on another PRU of the second PRU set, and wherein the terminal device is further caused to: transmit the PUSCH having a data transport block on the PRU and the other PUSCH having the same data transport block on the other PRU, a first redundancy version for the data transport block on the PRU being different from a second redundancy version for the same data transport block on the other PRU.

In one embodiment, wherein the plurality of preambles comprises a third preamble group for at least one SBFD time unit and a fourth preamble group for at least one non-SBFD time unit.

In one embodiment, wherein the third preamble group and fourth preamble group are subgroups of the first preamble group or second preamble group.

In one embodiment, indices of the preambles in the third preamble group and fourth preamble group are numbered uniformly, based on the PUSCH configuration, the first PRU set and the second PRU set are configured to locate at the same frequency resource location in different time units, and indices of PRUs in the first PRU set and second PRU set are numbered uniformly, and the preambles in the third preamble group and fourth preamble group are mapped, by the same mapping ratio, to the PRUs in the first PRU set and second PRU set, and wherein the same mapping ratio is determined based on a first number of the preambles in the third preamble group and fourth preamble group and a second number of the PRUs in the first PRU set and second PRU set.

In one embodiment, indices of the preambles in the third preamble group are numbered independently from indices of the preambles in the fourth preamble group, based on the PUSCH configuration, the first PRU set and the second PRU set are configured to locate at the same frequency resource location in different time units, and indices of PRUs in the first PRU set and second PRU set are numbered uniformly, and a first mapping and a second mapping are separately performed, and wherein the first mapping is between the preambles in the third preamble group and the PRUs in the first and second PRU sets, and the second mapping is between the preambles in the fourth preamble group and the PRUs in the first PRU and second PRU sets.

In one embodiment, indices of the preambles in the third preamble group and fourth preamble group are numbered uniformly, indices of PRUs in the first PRU set are numbered independently from indices of PRUs in the second PRU set, and a third mapping and a fourth mapping are separately performed, and wherein the third mapping is between the preambles in the third and fourth preamble groups and PRUs in the first PRU set, and the fourth mapping is between the preambles in the third and fourth preamble groups and PRUs in the second PRU set.

In one embodiment, indices of the preambles in the third preamble group are numbered independently from indices of the preambles in the fourth preamble group, indices of PRUs in the first PRU set are numbered independently from indices of PRUs in the second PRU set, and a fifth mapping and a sixth mapping are separately performed, the fifth mapping is between preambles in the third preamble group and PRUs in the first PRU set or between preambles in the third preamble group and PRUs in the second PRU set, and the sixth mapping is between preambles in the fourth preamble group and PRUs in the second PRU set or between preambles in the fourth preamble group and PRUs in the first PRU set.

In one embodiment, wherein the terminal device is further caused to at least one of: retransmit a PRACH for the first message based on a first power ramping step and retransmit a PUSCH on a PRU of the second PRU set based on a second power ramping step, the first power ramping step being different from the second power ramping step; or retransmit a PRACH for the first message based on a third power ramping step and retransmit a PUSCH on a PRU of the first PRU set based on a fourth power ramping step, the third power ramping step being different from the fourth power ramping step.

In one embodiment, wherein the terminal device is further caused to at least one of: retransmit a PRACH for the first message based on a first power ramping counter and retransmit a PUSCH on a PRU of the second PRU set based on a second power ramping counter, the first power ramping counter being different from the second power ramping counter; or retransmit a PRACH for the first message based on a third power ramping counter and retransmit a PUSCH on a PRU of the first PRU set based on a fourth power ramping counter, the third power ramping counter being different from the fourth power ramping counter.

In one embodiment, wherein a first retransmission number threshold is configured for retransmitting the first message on the SBFD time unit, and a second retransmission number threshold is configured for retransmitting the first message on the non-SBFD time unit, and wherein the terminal device is further caused to at least one of: based on determining that a number of retransmissions for the first message on the SBFD time unit is above the first retransmission threshold number, fallback the random access procedure to a four-step random access procedure; or based on determining that a number of retransmissions for the first message on the non-SBFD time unit is above the second retransmission threshold number, fallback the random access procedure to a four-step random access procedure.

In one embodiment, wherein an uplink resource is reserved on at least one non-SBFD time unit, and wherein the terminal device is further caused to: based on determining that a number of retransmissions for the first message is above a fallback number threshold, transmit the first message on the uplink resource.

A network device comprises a transceiver; and a processor communicatively coupled to the transceiver. The processor is configured to cause the network device to: transmit, to a terminal device, a physical uplink shared channel (PUSCH) configuration for a first message of a random access procedure, wherein the PUSCH configuration is associated with a first PUSCH Resource Unit (PRU) set for a subband non-overlapping full duplex (SBFD) time unit and a second PRU set for a non-SBFD time unit, and wherein the SBFD time unit is configured with frequency subbands for different link directions; and receive, on at least one of the first PRU set and second PRU set, a PUSCH for the first message to the network device.

In one embodiment, wherein the random access procedure is a two-step random access procedure, and wherein the first message is a message A (Msg A) of the two-step random access procedure.

In one embodiment, wherein the PUSCH configuration comprises a first common set of parameters, a SBFD set of parameters and a non-SBFD set of parameters.

In one embodiment, wherein: a candidate configured parameter of the SBFD set of parameters comprises at least one of a first PRU number of frequency division multiplexed (FDM) PRUs in the SBFD time unit, a first resource block (RB) number for a PRU in the SBFD time unit, a first modulation and coding scheme (MCS) order, a candidate configured parameter of the non-SBFD set of parameters comprises at least one of a second PRU number of frequency division multiplexed (FDM) PRUs in the non-SBFD time unit, a second resource block (RB) number for another PRU in the non-SBFD time unit, a second modulation and coding scheme (MCS) order, and the maximum value of at least one candidate configured parameter of the SBFD set of parameters is smaller than another maximum value of at least one corresponding candidate configured parameter of the non-SBFD set of parameters.

In one embodiment, wherein the PUSCH configuration indicates the second PRU set within the non-SBFD time unit and the PUSCH configuration comprises at least one offset value.

In one embodiment, wherein the second PRU set is within the non-SBFD time unit previous to the SBFD time unit, and wherein the at least one offset value comprise a MCS offset value.

In one embodiment, wherein the network device is caused to transmit the PUSCH configuration by: transmitting a SBFD PUSCH configuration indicating the first PRU set; and transmitting a non-SBFD PUSCH configuration indicating the second PRU set, the SBFD PUSCH configuration being configured independently from the non-SBFD PUSCH configuration.

In one embodiment, wherein the PUSCH configuration comprises a second common set of parameters, and wherein resources indicated by the second common set of parameters are adjusted based on a frequency subband for a first link direction of the SBFD time unit, such that the resources for the first PRU set are located within the frequency subband.

In one embodiment, wherein the network device is further caused to configure, to the terminal device, a plurality of preambles for a physical random access channel (PRACH), the plurality of preambles comprising a first group of preambles and a second group of preambles.

In one embodiment, wherein a preamble of the first group of preambles is mapped to a PRU of the first PRU set, and wherein another preamble of the second group of preambles is mapped to another PRU of the second PRU set.

In one embodiment, wherein: a first preamble of the first group of preambles is mapped to a first PRU of the first PRU set, a second preamble of the first group of preambles is mapped to a second PRU of the second PRU set, the second preamble being the same as or different from the first preamble, and a third preamble of the second group of preambles is mapped to a third PRU of the second PRU set.

In one embodiment, wherein a PRACH transmitted based on a preamble of the first group of preambles or second group of preambles is associated with a PUSCH transmitted on a PRU of the first PRU set and another PUSCH transmitted on another PRU of the second PRU set.

In one embodiment, wherein the plurality of preambles comprises a third preamble group for at least one SBFD time unit and a fourth preamble group for at least one non-SBFD time unit.

In one embodiment, wherein the third preamble group and fourth preamble group are subgroups of the first preamble group or second preamble group.

In one embodiment, wherein: indices of the preambles in the third preamble group and fourth preamble group are numbered uniformly, based on the PUSCH configuration, the first PRU set and the second PRU set are configured to locate at the same frequency resource location in different time units, and indices of PRUs in the first PRU set and second PRU set are numbered uniformly, and the preambles in the third preamble group and fourth preamble group are mapped, by the same mapping ratio, to the PRUs in the first PRU set and second PRU set, and wherein the same mapping ratio being determined based on a first number of the preambles in the third preamble group and fourth preamble group and a second number of the PRUs in the first PRU set and second PRU set.

In one embodiment, wherein: indices of the preambles in the third preamble group are numbered independently from indices of the preambles in the fourth preamble group, based on the PUSCH configuration, the first PRU set and the second PRU set are configured to locate at the same frequency resource location in different time units, and indices of PRUs in the first PRU set and second PRU set are numbered uniformly, and a first mapping and a second mapping are separately performed, and wherein the first mapping is between the preambles in the third preamble group and the PRUs in the first and second PRU sets, and the second mapping is between the preambles in the fourth preamble group and the PRUs in the first PRU and second PRU sets.

In one embodiment, wherein: indices of the preambles in the third preamble group and fourth preamble group are numbered uniformly, indices of PRUs in the first PRU set are numbered independently from indices of PRUs in the second PRU set, and a third mapping and a fourth mapping are separately performed, and wherein the third mapping is between the preambles in the third and fourth preamble groups and PRUs in the first PRU set, and the fourth mapping is between the preambles in the third and fourth preamble groups and PRUs in the second PRU set.

In one embodiment, wherein: indices of the preambles in the third preamble group are numbered independently from indices of the preambles in the fourth preamble group, indices of PRUs in the first PRU set are numbered independently from indices of PRUs in the second PRU set, and a fifth mapping and a sixth mapping are separately performed, the fifth mapping is between preambles in the third preamble group and PRUs in the first PRU set or between preambles in the third preamble group and PRUs in the second PRU set, and the sixth mapping is between preambles in the fourth preamble group and PRUs in the second PRU set or between preambles in the fourth preamble group and PRUs in the first PRU set.

A method of communication, comprising: receiving, at a terminal device from a network device, a physical uplink shared channel (PUSCH) configuration for a first message of a random access procedure, wherein the PUSCH configuration is associated with a first PUSCH Resource Unit (PRU) set for a subband non-overlapping full duplex (SBFD) time unit and a second PRU set for a non-SBFD time unit, and wherein the SBFD time unit is configured with frequency subbands for different link directions; and transmitting, on at least one of the first PRU set and second PRU set, a PUSCH for the first message to the network device.

A method of communication, comprising: transmitting, at a network device to a terminal device, a physical uplink shared channel (PUSCH) configuration for a first message of a random access procedure, wherein the PUSCH configuration is associated with a first PUSCH Resource Unit (PRU) set for a subband non-overlapping full duplex (SBFD) time unit and a second PRU set for a non-SBFD time unit, and wherein the SBFD time unit is configured with frequency subbands for different link directions; and receiving, on at least one of the first PRU set and second PRU set, a PUSCH for the first message to the network device.

A computer readable medium having instructions stored thereon, the instructions, when executed on at least one processor, causing the at least one processor to perform the method according to the above embodiments.

What is claimed is:

1. A terminal device comprising:
a transceiver; and
a processor communicatively coupled to the transceiver, and the processor is configured to cause the terminal device to:
receive, from a network device, a physical uplink shared channel (PUSCH) configuration for a first message of a random access procedure,
wherein the PUSCH configuration is associated with a first PUSCH Resource Unit (PRU) set for a subband non-overlapping full duplex (SBFD) time unit and a second PRU set for a non-SBFD time unit, and wherein the SBFD time unit is configured with frequency subbands for different link directions; and
transmit, on at least one of the first PRU set and second PRU set, a PUSCH for the first message to the network device.

2. The terminal device of claim 1, wherein the random access procedure is a two-step random access procedure, and wherein the first message is a message A (Msg A) of the two-step random access procedure.

3. The terminal device of claim 1, wherein the PUSCH configuration comprises a first common set of parameters, a SBFD set of parameters and a non-SBFD set of parameters, and wherein the terminal device is further caused to determine the first PRU set and second PRU set by:
determining, based on the first common set of parameters and SBFD set of parameters, the first PRU set within the SBFD time unit; and
determining, based on the first common set of parameters and non-SBFD set of parameters, the second PRU set within the non-SBFD time unit.

4. The terminal device of claim 3, wherein:
a candidate configured parameter of the SBFD set of parameters comprises at least one of a first PRU number of frequency division multiplexed (FDM) PRUs in the SBFD time unit, a first resource block (RB) number for a PRU in the SBFD time unit, a first modulation and coding scheme (MCS) order,
a candidate configured parameter of the non-SBFD set of parameters comprises at least one of a second PRU number of frequency division multiplexed (FDM) PRUs in the non-SBFD time unit, a second resource block (RB) number for another PRU in the non-SBFD time unit, a second modulation and coding scheme (MCS) order, and
the maximum value of at least one candidate configured parameter of the SBFD set of parameters is smaller than another maximum value of at least one corresponding candidate configured parameter of the non-SBFD set of parameters.

5. The terminal device of claim 1, wherein the PUSCH configuration indicates the second PRU set within the non-SBFD time unit and the PUSCH configuration comprises at least one offset value, and wherein the terminal device is further caused to determine the first PRU set by:
determining the first PRU set based on the second PRU set and the at least one offset value.

6. The terminal device of claim 5, wherein the second PRU set is within the non-SBFD time unit previous to the SBFD time unit, and wherein the at least one offset value comprise a MCS offset value.

7. The terminal device of claim 1, wherein the terminal device is caused to receive the PUSCH configuration by:
receiving a SBFD PUSCH configuration indicating the first PRU set; and
receiving a non-SBFD PUSCH configuration indicating the second PRU set, the SBFD PUSCH configuration being configured independently from the non-SBFD PUSCH configuration.

8. The terminal device of claim 1, wherein:
the PUSCH configuration comprises a second common set of parameters, and
in the case that the terminal device is to transmit the PUSCH on a SBFD time unit, resources indicated by the second common set of parameters are adjusted based on a frequency subband for a first link direction of the SBFD time unit, such that the resources for the first PRU set are located within the frequency subband.

9. The terminal device of claim 1, wherein the terminal device is further caused to:
determine whether at least one PRU of the first PRU set is located within a frequency subband for a first link direction of the SBFD time unit and the at least one PRU not overlaps with a random access channel occasion (RO) for transmitting a random access channel; and
determine the at least one PRU as valid based on determining that the at least one PRU is located within the frequency subband and the at least one PRU not overlaps with the RO.

10. The terminal device of claim 1, wherein:
the terminal device is configured with a plurality of preambles for a physical random access channel (PRACH), the plurality of preambles comprising a first group of preambles and a second group of preambles.

11. The terminal device of claim 10, wherein a preamble of the first group of preambles is mapped to a PRU of the first PRU set, and wherein another preamble of the second group of preambles is mapped to another PRU of the second PRU set.

12. The terminal device of claim 10, wherein:
a first preamble of the first group of preambles is mapped to a first PRU of the first PRU set,
a second preamble of the first group of preambles is mapped to a second PRU of the second PRU set, the second preamble being the same as or different from the first preamble, and
a third preamble of the second group of preambles is mapped to a third PRU of the second PRU set.

13. The terminal device of any of claims 10 to 12, wherein a PRACH for the first message is associated with a PUSCH transmitted on a PRU of the first PRU set and another PUSCH transmitted on another PRU of the second PRU set, and wherein the terminal device is further caused to:
transmit the PUSCH having a data transport block on the PRU and the other PUSCH having the same data transport block on the other PRU, a first redundancy version for the data transport block on the PRU being different from a second redundancy version for the same data transport block on the other PRU.

14. The terminal device of any of claims 10 to 12, wherein the plurality of preambles comprises a third preamble group for at least one SBFD time unit and a fourth preamble group for at least one non-SBFD time unit.

15. The terminal device of claim 14, wherein the third preamble group and fourth preamble group are subgroups of the first preamble group or second preamble group.

16. The terminal device of claim 14 or 15, wherein:
indices of the preambles in the third preamble group and fourth preamble group are numbered uniformly,
based on the PUSCH configuration, the first PRU set and the second PRU set are configured to locate at the same frequency resource location in different time units, and indices of PRUs in the first PRU set and second PRU set are numbered uniformly, and
the preambles in the third preamble group and fourth preamble group are mapped, by the same mapping ratio, to the PRUs in the first PRU set and second PRU set, and
wherein the same mapping ratio is determined based on a first number of the preambles in the third preamble group and fourth preamble group and a second number of the PRUs in the first PRU set and second PRU set.

17. The terminal device of claim 14 or 15, wherein:
indices of the preambles in the third preamble group are numbered independently from indices of the preambles in the fourth preamble group,
based on the PUSCH configuration, the first PRU set and the second PRU set are configured to locate at the same frequency resource location in different time units, and indices of PRUs in the first PRU set and second PRU set are numbered uniformly, and
a first mapping and a second mapping are separately performed, and wherein the first mapping is between the preambles in the third preamble group and the PRUs in the first and second PRU sets, and the second mapping is between the preambles in the fourth preamble group and the PRUs in the first PRU and second PRU sets.

18. The terminal device of claim 14 or 15, wherein:
indices of the preambles in the third preamble group and fourth preamble group are numbered uniformly,
indices of PRUs in the first PRU set are numbered independently from indices of PRUs in the second PRU set, and
a third mapping and a fourth mapping are separately performed, and wherein the third mapping is between the preambles in the third and fourth preamble groups and PRUS in the first PRU set, and the fourth mapping is between the preambles in the third and fourth preamble groups and PRUs in the second PRU set.

19. A method of communication, comprising:
receiving, at a terminal device from a network device, a physical uplink shared channel (PUSCH) configuration for a first message of a random access procedure,
wherein the PUSCH configuration is associated with a first PUSCH Resource Unit (PRU) set for a subband non-overlapping full duplex (SBFD) time unit and a second PRU set for a non-SBFD time unit, and wherein the SBFD time unit is configured with frequency subbands for different link directions; and
transmitting, on at least one of the first PRU set and second PRU set, a PUSCH for the first message to the network device.

20. A network device comprises:
a transceiver; and
a processor communicatively coupled to the transceiver. The processor is configured to cause the network device to:
transmit, to a terminal device, a physical uplink shared channel (PUSCH) configuration for a first message of a random access procedure,
wherein the PUSCH configuration is associated with a first PUSCH Resource Unit (PRU) set for a subband non-overlapping full duplex (SBFD) time unit and a second PRU set for a non-SBFD time unit, and wherein the SBFD time unit is configured with frequency subbands for different link directions; and
receive, on at least one of the first PRU set and second PRU set, a PUSCH for the first message to the network device.
